(19) United States
(12) Patent Application Publication
(10) Pub. No.: US 2002/0116416 A1
(43) Pub. Date: Aug. 22, 2002

(54) Methods and systems for processing embedded objects

(76) Inventors: Falko Tesch, Hamburg (DE); Matthias Breuer, Seevetal (DE); Juergen Pingel, Geesthacht (DE)

Correspondence Address: SONNENSCHEIN NATH & ROSENTHAL, P.O. BOX 061080, WACKER DRIVE STATION, CHICAGO, IL, 60606-1080, US

(21) Appl. No.: 09/929,742

(22) Filed: Aug. 13, 2001

Related U.S. Application Data
(60) Provisional application No. 60/296,095, filed on Jun. 5, 2001.

(30) Foreign Application Priority Data
Aug. 11, 2000 (EP) 00117470.5

(51) Int. Cl. G06F 15/00; G06F 17/21

(52) U.S. Cl. 707/516; 707/515; 707/530

(57) ABSTRACT

Methods, systems, and articles of manufacture consistent with the present invention provide processing of a document containing an embedded object having a first format corresponding to a first program that is unavailable on the data processing system. It is determined whether the first program is an unavailable program. When it is determined that the first program is unavailable, the embedded object is converted into a second format different from the first format that is suitable for use with a second program that is available on the data processing system.

### CROSS-REFERENCE TO RELATED APPLICATIONS

The following identified U.S. and foreign patent applications are relied upon and are incorporated by reference in this application:

European Patent Application No. 001 17470.5, entitled “METHOD AND APPARATUS OF PROCESSING EMBEDDED OBJECTS”, filed on Aug. 11, 2000; and

U.S. Provisional Patent Application No. 60/296,095, entitled “METHOD AND APPARATUS OF PROCESSING EMBEDDED OBJECTS”, filed on Jun. 5, 2001.

### FIELD OF THE INVENTION

The present invention relates to the processing of electronic documents, and in particular, the invention relates to the processing of embedded objects in electronic documents.

### BACKGROUND OF THE INVENTION

One method for exchanging data between a source document and a target document is to copy a part of the source document into the target document by using a clipboard. Thereby, a user can temporarily copy a part of the source document to the clipboard and then paste the copied part of the source document from the clipboard into the target document. The part of the source document that has been inserted into the target document is called an embedded object.

This method of exchanging data through the clipboard has the disadvantage that if the source document and the target document require different application programs for editing, then it is not possible to edit the inserted part of the source document using the application program of the target document. To overcome this disadvantage, several approaches have been developed, such as object linking and embedding (OLE) technology and OpenDoc® technology. OLE technology will be described below in more detail. OpenDoc is a registered trademark of Apple Computer, Inc. All other company and product names herein may be trademarks of their respective companies.

OLE is a technology that is used to enable the exchange of data between application programs, or, to be more accurate, to enable the incorporation of a document generated using one application program into a document generated using another application program. An application program generates documents in accordance with a certain format. The formats of the documents generated by different application programs are usually different from each other. This is the main reason why documents require certain application programs to enable a user to display and edit their contents.

By using OLE, however, a document that was generated using a certain application program may contain embedded objects that were generated using a different application program. Documents containing such embedded objects are called compound documents.

In OLE, when a source document is generated using a certain application program, it is known as an OLE server. Using the OLE server, the source document, in part or as a whole, can then be incorporated into a target document as an embedded object, which is also known as an OLE object. This can be done, for example, by actually “embedding” the OLE object into the target document, which means that a copy of the source document or a part of the source document is fully incorporated into the target document together with some information about the application program by which the source document was generated. Another possibility for incorporating the embedded object into the target document, which is also referred to as an embedding document, consists of inserting a link to the source document into the target document, usually in the form of a pointer. Such a link only contains information about the location of the source document and about which fraction of the source document that should appear in the target document.

Both techniques, actual “embedding” and “linking”, make it possible to incorporate a source document or a fraction of it into a target document. Moreover, both techniques facilitate the editing of the embedded object since, in both cases, the embedded object contains information about the application program which was used to generate the embedded object.

FIG. 1A depicts a compound document 100, which itself is a text document 105, and contains a graphics object 110, a table 120 and a formula 130 as embedded objects.

The embedded objects 110, 120 and 130 may actually be “embedded” in the target document, or they may be stored in one or more separate files. In either case, the embedded objects 110, 120 and 130 may have different formats and may require different application programs for processing. For example, the target document 100, which is a text document, may be a Microsoft® Word document, the graphics object 110 may be a CorelDRAW® graphics, the table 120 may be an Microsoft® Excel table, and the formula 130 may be a Microsoft® Equation formula. Microsoft is a registered trademark of Microsoft Corporation. CorelDRAW is a registered trademark of Corel Corporation.

When the target document 100 is presented on a video display, as schematically depicted in FIG. 1, the embedded objects 110, 120 and 130 are displayed as if they are a part of the text document 100, however, they may actually be stored in different files linked to the text document 100. Referring to FIG. 1B, in that case, rather than containing the embedded objects 110, 120 and 130 themselves, the text document 100 contains pointers 115, 125 and 135 to the embedded objects 110, 120 and 130. A first pointer 115 points to the graphics object 110, a second pointer 125 points to the table 120, and a third pointer 135 points to the formula 130. The three embedded objects 110, 120 and 130 are stored in different files 140, 150, and 160, respectively, with each file 140, 150 and 160 having a different format. The embedded objects 110, 120 and 130 are respectively “linked” to the target document 100 via the first pointer 115, the second pointer 125, and the third pointer 135.

When a user processes the target document 100, for example, when editing the target document 100, the user may also want to edit the embedded objects 110, 120 and 130. For example, assuming the application program used by the user for editing the target document 100 is capable of displaying the embedded objects 110, 120 and 130 (which is not necessarily the case), the user may want to edit the graphics object 110. On request by the user (for example, by double-clicking on the graphics object 110 with a mouse button), the OLE server is loaded, which means that the application program required for editing the graphics object 110 is started thereby enabling the user to edit the graphics object 110. Since the embedded objects 100, 120 and 130, whether they are actually “embedded” or whether they are just “linked”, contain information about their corresponding OLE server, this OLE server can be loaded to facilitate editing of the embedded objects 110, 120 and 130.

The editing can be done performed by the user by providing the user with a new window on the video display, in which the OLE server is running (out-of-place editing). Alternatively, the editing can be done in-place, which means in the application program used for editing the target document 100, a taskbar and possibly a toolbox of the OLE server required for editing the embedded objects 110, 120 and 130 appear.

Embedded objects and the data exchange tools that make them possible, such as OLE or OpenDoc®, are convenient for the user since they facilitate editing of embedded objects contained in a certain target document although the application program of this target document in principle would not allow such an editing. If the embedded objects are truly “embedded”, which means a copy of the source document object is contained in the target document, then the source document is not affected by the editing process. However, if the embedded objects are just “linked”, then the editing of the embedded objects directly affects the source document that is linked to the embedded objects. In this latter case, the editing enables a user to amend or update a lot of target documents simultaneously just by updating or amending the embedded objects contained therein.

However, editing an embedded object when processing a target document on a data processing system requires that the application program corresponding to the embedded object be available on the data processing system. This is not always the case, depending on how a particular data processing system is configured. For example, some application programs or components of application programs are not available on certain operating systems. In that case, the user may be unable to edit the embedded object.

In some cases, a user trying to edit a target document containing embedded objects may not even be provided with a display of the embedded objects in the target document. Embedded objects usually contain a Metafile with graphic information about their content, so that they can, based on this Metafile, be displayed to a user even if the OLE server for editing the embedded object is not available on the data processing system. Sometimes, however, the data processing system or the OLE server is not even capable of displaying the embedded object based on its Metafile. In that case, the user will not see the embedded object.

### SUMMARY OF THE INVENTION

Methods, system, and articles of manufacture consistent with the present invention convert an embedded object of a document from a first format of a first application program to a second format of a second application program, which is different from the first format. This allows the user to display and edit the embedded object on the data processing system using the second application program, which is available on the data processing system, when the first application program may not be available on the data processing system. For example, if a text document contains a formula as an embedded object that was created using Application Program A, which is not available (e.g., not installed) on the data processing system, the user can request to convert the formula to the format of Application Program B, which is available on the data processing system. Additionally, the user can make a request to convert the embedded object to a format that is different from its present format when the user saves the document to a secondary storage device.

In accordance with methods consistent with the present invention, a method in a data processing system is provided for processing a document containing an embedded object having a first format corresponding to a first program. The method comprises the steps of determining whether the first program is an unavailable program, and, when it is determined that the first program is an unavailable program, converting the embedded object into a second format different from the first format that is suitable for use with a second program that is available on the data processing system.

In accordance with methods consistent with the present invention, a method in a data processing system is provided for processing a document containing an embedded object having a first format corresponding to a first application program. The method comprises the steps of determining whether the first program is an unavailable program; when it is determined that the first program is an unavailable program, converting the embedded object into a second format different from the first format that is suitable for use with a second program that is available on the data processing system; receiving an indication of a third format from a user; converting the embedded object into the third format; and storing the embedded object in the third format.

In accordance with methods consistent with the present invention, a method in a data processing system containing a plurality of programs, each with an associated format, is provided for processing a document containing an embedded object having an originating format corresponding to an originating program. The method comprises the steps of determining whether the originating program is unavailable; when it is determined that the originating program is unavailable, determining which of the plurality of programs are available on the data processing system, displaying the associated formats of the available programs to a user, and receiving an indication of a selected one of the displayed formats from the user; and converting the embedded object into the selected format.

In accordance with methods consistent with the present invention, a method in a data processing system for processing a document containing an embedded object having a first format corresponding to a first program is provided. The data processing system has a memory. The method comprises the steps of initiating loading of the document into the memory; while the document is being loaded, determining whether the first program is unavailable, when it is determined that the first program is unavailable, converting the embedded object into a second format different from the first format that is suitable for use with a second program that is available on the data processing system; after the document is loaded, receiving a request from the user to edit the embedded object; and responsive to receiving the request from the user, converting the embedded object into a third format that is suitable for use with a third program that is available on the data processing system.

In accordance with systems consistent with the present invention, a data processing system is provided. The data processing system comprises a secondary storage device comprising a target document containing an embedded object having a first format corresponding to a first program; a memory comprising a computer program that determines whether the first program is an unavailable program, and, when it is determined that the first program is an unavailable program, converts the embedded object into a second format different from the first format that is suitable for use with a second program that is available on the data processing system; and a processing unit that runs the computer program.

In accordance with articles of manufacture consistent with the present invention, a computer-readable medium is provided that contains instructions that cause a data processing system to perform a method for processing a document containing an embedded object having a first format corresponding to a first program. The method comprises the steps of determining whether the first program is an unavailable program; and, when it is determined that the first program is an unavailable program, converting the embedded object into a second format different from the first format that is suitable for use with a second program that is available on the data processing system.

In accordance with articles of manufacture consistent with the present invention, a computer-readable medium is provided that contains instructions that cause a data processing system to perform a method for processing a document containing an embedded object having a first format corresponding to a first program. The method comprises the steps of determining whether the first program is an unavailable program; when it is determined that the first program is an unavailable program, converting the embedded object into a second format different from the first format that is suitable for use with a second program that is available on the data processing system; receiving an indication of a third format from a user; converting the embedded object into the third format; and storing the embedded object in the third format.

In accordance with articles of manufacture consistent with the present invention, a computer-readable medium is provided that contains instructions that cause a data processing system containing a plurality of programs, each with an associated format, to perform a method for processing a document containing an embedded object having an originating format corresponding to an originating program. The method comprises the steps of determining whether the originating program is unavailable; when it is determined that the originating program is unavailable, determining which of the plurality of programs are available on the data processing system, displaying the associated formats of the available programs to a user, and receiving an indication of a selected one of the displayed formats from the user; and converting the embedded object into the selected format.

In accordance with articles of manufacture consistent with the present invention, a computer-readable medium is provided that contains instructions that cause a data processing system to perform a method for processing a document containing an embedded object having a first format corresponding to a first program. The method comprises the steps of initiating loading of the document into the memory; while the document is being loaded, determining whether the first program is unavailable, when it is determined that the first program is unavailable, converting the embedded object into a second format different from the first format that is suitable for use with a second program that is available on the data processing system; after the document is loaded, receiving a request from the user to edit the embedded object; and responsive to receiving the request from the user, converting the embedded object into a third format that is suitable for use with a third program that is available on the data processing system.

In accordance with articles of manufacture consistent with the present invention, a computer-readable memory device encoded with a data structure with entries is provided. Each entry reflects embedded data in a document that is accessed by a host program which is encoded on the memory device and which is run by a processor in a system. Each entry comprises a storage area in which is stored a first identifier of an original program that was utilized during creation of the embedded data and in which is stored a second identifier of an available program to be used for accessing the embedded data when the original program becomes unavailable in the system, wherein the available program is different than the original program.

In accordance with systems consistent with the present invention, a data processing system for processing a document containing an embedded object having a first format corresponding to a first program is provided. The data processing system comprises means for determining whether the first program is an unavailable program, and means for converting the embedded object into a second format different from the first format that is suitable for use with a second program that is available on the data processing system, when it is determined that the first program is an unavailable program.

In accordance with methods consistent with the present invention, a method in a data processing system is provided. The data processing system comprises a document with data in a native format and with embedded data in a nonnative format. The embedded data is suitable for use with a program. The method comprises the steps of receiving an indication of a different format suitable for use with a different program, and converting the embedded data into the different format.

In accordance with articles of manufacture consistent with the present invention, a computer-readable medium is provided that contains instructions that cause a data processing system to perform a method. The data processing system comprises a document with data in a native format and with embedded data in a nonnative format. The embedded data is suitable for use with a program. The method comprises the steps of receiving an indication of a different format suitable for use with a different program, and converting the embedded data into the different format.

The above-mentioned and other features, utilities, and advantages of the invention will become apparent from the following detailed description of preferred embodiments of the invention together with the accompanying drawings.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying drawings.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1A depicts an example of a document containing embedded objects;

FIG. 1B depicts the document of FIG. 1A containing pointers to embedded objects;

FIGS. 1C-1E depict files containing embedded objects pointed to by the pointers in FIG. 1B;

FIG. 2 depicts a block diagram of a data processing system with which embodiments of the present invention may be implemented;

FIG. 3 depicts an example of a document containing an embedded object;

FIG. 4 depicts a block diagram of a data structure with which embodiments of the present invention may be implemented;

FIG. 5 depicts a block diagram of a client-server based data processing system with which embodiments of the present invention may be implemented;

FIG. 6 depicts a flow diagram illustrating the steps of processing a target document, in accordance with methods, systems and articles of manufacture consistent with the present invention;

FIG. 7 depicts a flow diagram illustrating the steps of converting an embedded object, which is present in a target document that has been imported into memory for use with a target application computer program, into a format of an application program that is available on the data processing system, in accordance with methods, systems and articles of manufacture consistent with the present invention;

FIG. 8 depicts an import mapping table in accordance with methods, systems and articles of manufacture consistent with the present invention;

FIG. 9 depicts a schematic illustration of a window on a video display in accordance with methods, systems, and articles of manufacture consistent with the present invention;

FIG. 10 depicts a flow diagram illustrating the steps of importing/exporting a data stream of a target document in accordance with methods, systems, and articles of manufacture consistent with the present invention;

FIG. 11 depicts a flow diagram illustrating a sample conversion of an embedded object to a target format in accordance with methods, systems, and articles of manufacture consistent with the present invention;

FIG. 12 depicts a flow diagram illustrating the steps of converting an embedded object into a target application program object format during a save of the target document, in accordance with methods, systems and articles of manufacture consistent with the present invention;

FIG. 13 depicts an export mapping table in accordance with methods, systems and articles of manufacture consistent with the present invention; and

FIG. 14 depicts a schematic illustration of another window on the video display in accordance with methods, systems, and articles of manufacture consistent with the present invention.

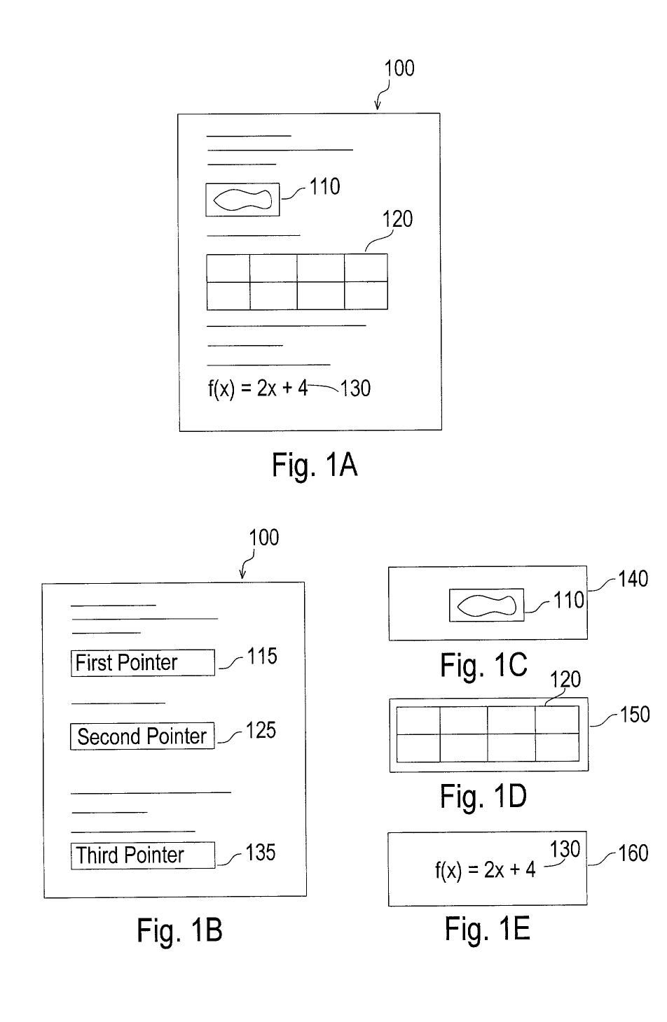

### DETAILED DESCRIPTION OF THE INVENTION

Reference will now be made in detail to an implementation consistent with the present invention as illustrated in the accompanying drawings. Wherever possible, the same reference numbers will be used throughout the drawings and the following description to refer to the same or like parts.

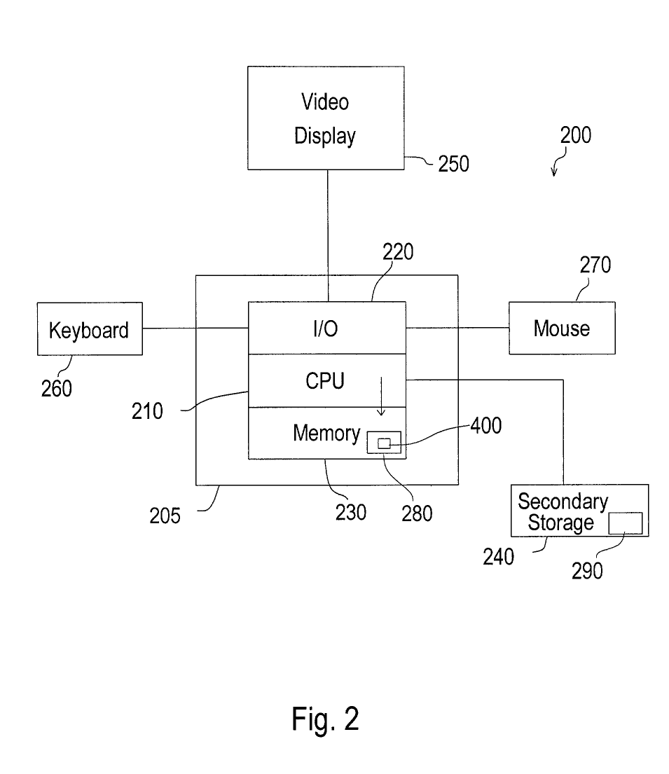

FIG. 2 depicts a block diagram of a data processing system 200 suitable for practicing methods and implementing systems consistent with the present invention. The data processing system 200 comprises a central processing unit (CPU) 210, an input output I/O unit 220, a memory 230, a secondary storage device 240, and a video display 250. The data processing system 200 may further comprise standard input devices such as a keyboard 260, a mouse 270 or a speech processing means (not illustrated).

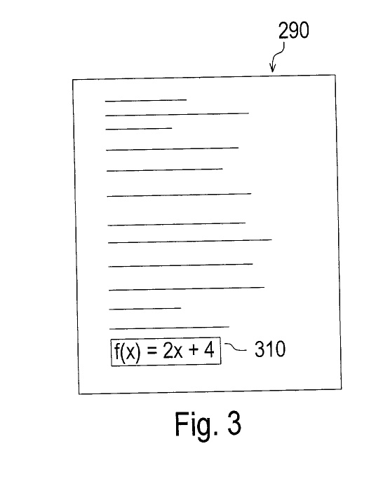

The memory 230 contains a computer program 280. Computer program 280 provides an interface for manipulating the content of a target document and for making user selections via the keyboard 260. An example of a target document 290 is depicted in FIG. 3. The exemplary target document 290 contains a formula 310 as an embedded object and will be described below. The content of the exemplary target document 290 is viewed on the video display 250.

FIG. 3 depicts the target document 290 as it is viewed by the user on the video display 250. As illustrated, the target document 290 is a text document that contains formula 310 as an embedded object. The target document 290 can be, for example, a Microsoft® Word file. The server application program that was used to create the formula 310 was, for example, the Microsoft® Equation editor, which in this example is not available on the data processing system 200. One skilled in the art will recognize that the target document 290 is not limited to being a text document. For example, the target document 290 could be a slide show presentation and the embedded object could be a spreadsheet document. For the purposes of the example depicted in FIG. 3, the data processing system has available thereon StarOffice® produced by Sun Microsystems, Palo Alto, Calif., USA, together with its module StarOffice® Math and a filter for converting Microsoft® Equation formulas into the StarOffice® Math format.

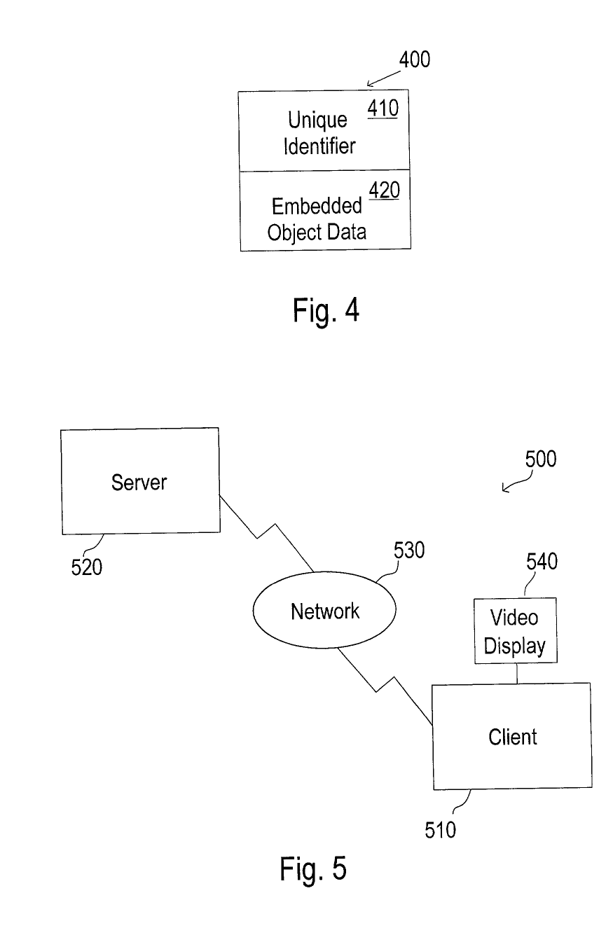

Referring back to FIG. 2, the computer program 280 includes a data structure 400 having entries reflecting each embedded object of the target document 290. FIG. 4 depicts a more detailed diagram of data structure 400. The sample data structure 400 that is depicted in FIG. 4 illustrates an entry for, for example, a single embedded object that is contained in a target document. The data structure 400 has entries for a unique identifier 410 of the embedded object and embedded object data 420 of the embedded object. The unique identifier 410 identifies an application program for which the embedded object is formatted. Thus, the unique identifier 410 of the embedded object is similar to a “GlobalNameld” of Microsoft® OLE objects. The embedded object data 420 contains the data that defines the embedded object for insertion into an application program object structure, which defines the format of an application program object. For example, consider the embedded object formula 310 depicted in FIG. 3. In that example, the data structure 400 for the formula 310 comprises a unique identifier 410 of the program used to make the formula 310 and embedded object data 420 of the formula 310 (e.g., the actual equation of the formula).

Although aspects of one implementation are depicted as being stored in memory, one skilled in the art will appreciate that all or part of systems and methods consistent with the present invention may be stored on or read from other computer-readable media, such as secondary storage devices, like hard disks, floppy disks, and CD-ROM; a carrier wave received from a network such as the Internet; or other forms of ROM or RAM. Further, although specific components of data processing system 200 have been described, one skilled in the art will appreciate that a data processing system suitable for use with methods, systems, and articles of manufacture consistent with the present invention may contain additional or different components.

One skilled in the art will appreciate that methods and systems consistent with the present invention may also be implemented in a client-server environment, like the one depicted in FIG. 5. FIG. 5 depicts a block diagram of a client-server based data processing system 500 with which methods, systems, and articles of manufacture consistent with the present invention may be implemented. A client computer system 510 and a server computer system 520 are each connected to a network 530, such as a Local Area Network, Wide Area Network, or the Internet. A target document is displayed on a video display 540 of the client computer system 510 while some or all steps of the processing as described below are carried out on the server computer system 520, which is accessed by the client computer system 510 over the network 530.

Referring to FIG. 3, in a typical system, when the user would attempt to edit the formula 310, which has been displayed on the video display 250 based on its metafile, the user would be unable to edit the formula 310 since the server application program is not present on the data processing system. Also, the data processing system may not even be able to display the formula 310 on the video display 250.

In accordance with methods, systems, and articles of manufacture consistent with the present invention, the user is able to edit formula 310 because the computer program converts the formula 310 into an object format of an application program that is available on the data processing system and that is suitable for editing the formula 310 in its converted format.

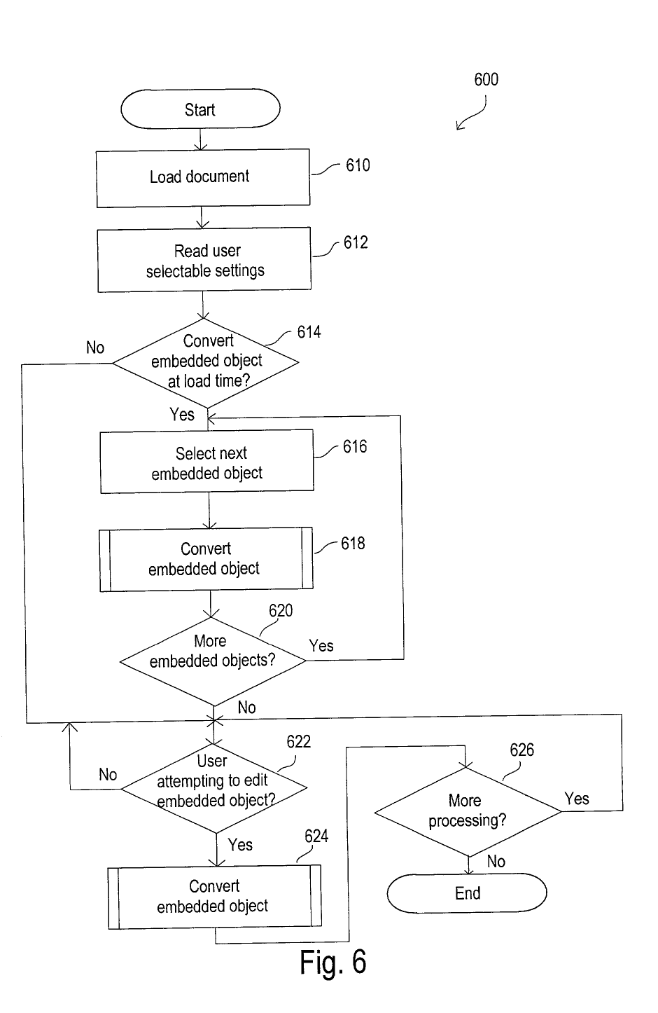

The conversion can be done either automatically by the computer program where the user has selected preset settings to perform an automatic conversion (e.g., all Microsoft® Equation objects are converted to StarOffice® Math objects) or manually where the user is presented with possible formats for conversion at runtime (e.g., when the user selects the embedded object to edit). Another user selectable setting identifies whether an embedded object is maintained in its original application program object format when it is imported or selected for editing. Upon a request received from the user, the computer program provides a display of all user selectable settings on the video display 250 for modification by the user. The computer program sets a particular user selectable setting to “enabled” when the user selects that user selectable setting to occur and sets the user selectable setting to “disabled” when the user selects for that user selectable setting to not occur. An implementation of these options will be described below with reference to FIG. 6

FIG. 6 depicts a flow diagram 600 illustrating the steps of processing a target document. In this description, the target document and the formula 310 of FIG. 3 are referred to as an example. The computer program loads the target document, for example, from the secondary storage 240 into memory 230 based on, for example, a request by the user to load the target document (step 610). When the computer program loads the target document, the computer program identifies any embedded objects that are present in the target document. The computer program does this by using an import filter. Import filters are well known to one having skill in the art. For example, import filters are discussed in James D. Murray, et al., Encyclopedia of Graphic File Formats with CDROM, O'Reilly & Associates, ISBN 1565921615, which is incorporated herein by reference. The computer program reads the target document as a data stream from beginning to end and, based on import filter settings, identifies the start of the embedded object by identifying a unique identifier associated with the embedded object. As discussed above, the unique identifier of the embedded object identifies the server application program that was used to create the embedded object. Therefore, the embedded object needs a unique identifier that the computer program can recognize in order for the computer program to identify which server application program was used to create the embedded object. Referring to the example depicted in FIG. 3, the computer program identifies formula 310 as an embedded object, which has a unique identifier 410 that indicates that its server application program is Microsoft® Equation.

The computer program then reads the user selectable settings (step 612). The computer program then determines, based on the user selectable settings, whether any embedded objects that are found in the target document are to be converted to a target format when the target document is loaded (step 614). If the computer program determines that an embedded object is to be converted when the target document is loaded in step 614, then the computer program selects that embedded object for conversion (step 616).

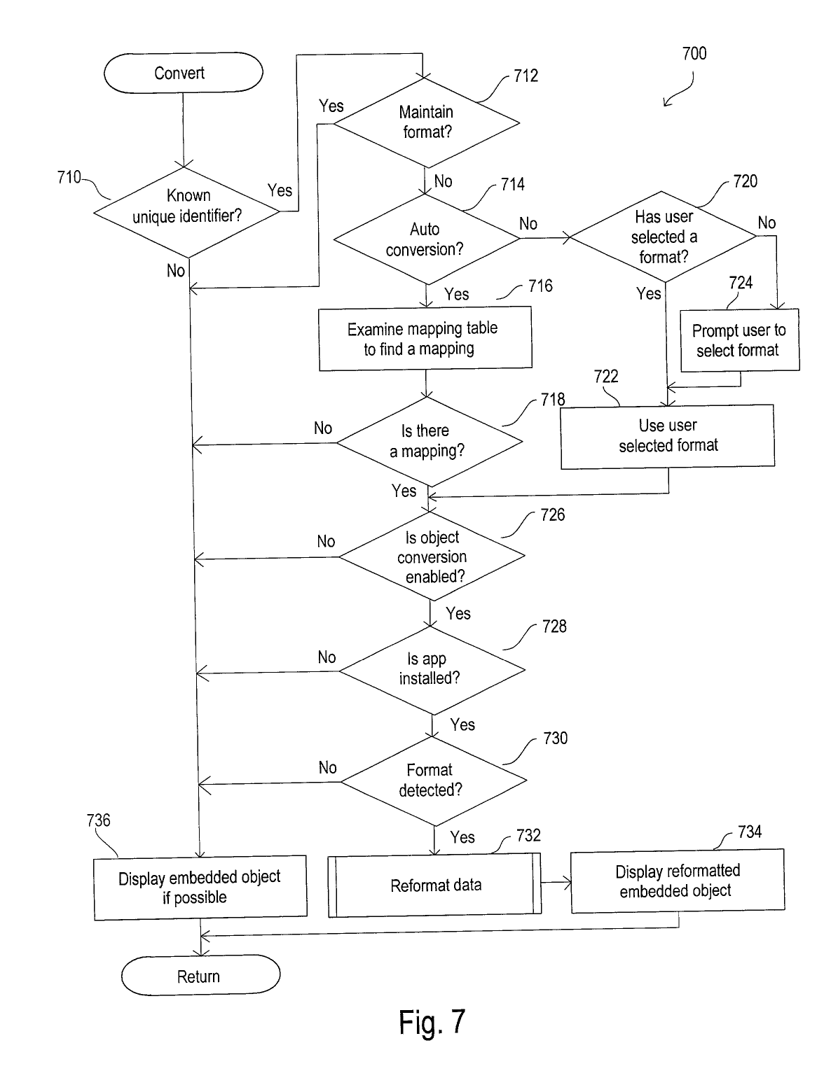

The computer program then converts the embedded object to the target format, if possible, and displays the embedded object on the video display (step 618). An implementation of the conversion will be described below with reference to FIG. 7.

After the computer program converts the reformatted embedded object in step 618, the computer program determines whether there are more embedded objects to convert (step 620). If there are more embedded objects to convert in step 620, then the computer program returns to step 616 to select the next embedded object for conversion.

If the computer program determines that there are no embedded objects to be converted when the target document is loaded in step 614 or that there are no more embedded object to convert in 620, then the computer program determines whether the user is attempting to edit an embedded object in the target document (step 622). The computer program receives an indication from the user that the user wants to edit an embedded object, for example, when the user selects the embedded object on the video display using the button on the mouse. For example, when a user wants to edit the formula 310 in the target document, the user clicks on the formula 310 on the video display 250 using the button on the mouse 270.

If the computer program determines that the user is attempting to edit an embedded object in step 622, then the computer program converts the embedded object to a target format, if necessary (step 624). The computer program performs the same process for converting the embedded object when the embedded object is selected for editing as it does for converting the embedded object when the target document is loaded. The implementation of the conversion will be described below with reference to FIG. 7. The computer program will convert the embedded object to a target format when the embedded object's server application program is not available on the data processing system or when the user selectable settings call for the conversion.

After the conversion is completed in step 624, the user is able to edit the reformatted embedded object. The computer program then determines whether the target document is to be further processed (step 626). If the computer program determines that the target document is to be further processed in step 626, then the computer program returns to step 622 to determine whether the user is attempting to edit an embedded object. If the computer program determines that there is to be no further processing in step 626, then the computer program ends processing.

FIG. 7 depicts a flow diagram 700 illustrating the steps of converting an embedded object, which is present in a target document that is imported into memory for use with the target application computer program, into an object format of an application program that is available on the data processing system.

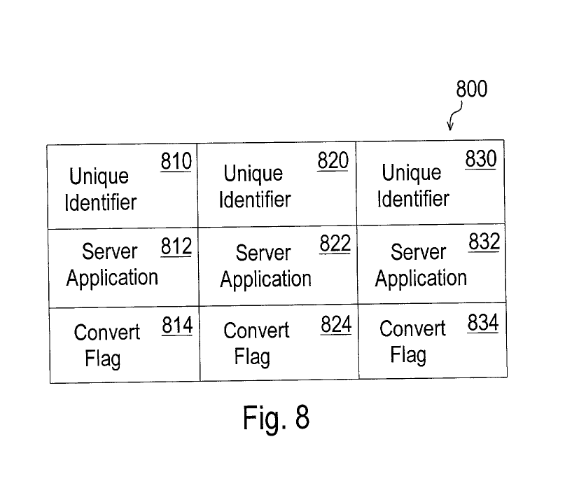

The computer program first determines whether it recognizes the unique identifier of the embedded object (step 710). This is done by comparing the unique identifier to known unique identifiers on the data processing system. Known unique identifiers are stored in an import mapping table, as illustrated in FIG. 8.

FIG. 8 depicts a sample import mapping table 800, which has entries for three unique identifiers 810, 820 and 830. For each unique identifier, such as embedded object identifier 810, the mapping table 800 has entries for a corresponding target application program 812 that is present on the data processing system and a convert flag 814 indicating whether the embedded object should be converted to the target application program format. Each of the mapping table entries 800 is similarly configured. The convert flag 814 is set to “enabled” when the embedded object should be converted and is set to “disabled” when the embedded object should not be converted. The computer program sets the convert flag for each target application program based on a user selectable setting selected by the user. The default setting of the convert flag 814 is “enabled”. For example, when the user wants to edit the formula 310 in FIG. 3, the user selects the formula 310 on the video display 250 with a click of the mouse 270. The computer program then automatically sets the convert flag 814 to “enabled”, which enables conversion of the formula 310 to a format of an application program on the data processing system. Once, the computer program completes the conversion, as described below, the user can edit the formula 310. Also, the unique identifier 410 of the formula 310 is changed by the computer program to indicate that the server application program for the formula has changed (e.g., it is currently StarOffice® Math). Conversion and editing will be described in more detail below.

Referring back to FIG. 7, the computer program then determines whether the user setting to maintain the embedded object in its original format is “disabled” (step 712). If the user setting to maintain the embedded object in its original format is “disabled” in step 712, then the computer program determines whether the user setting to perform an automatic conversion is “enabled” (step 714). If the user setting for automatic conversion is “enabled”, then the computer program examines the import mapping table 800, as described above, to determine whether there is a mapping of the embedded object's server application program to an application program present on the data processing system (step 716).

After examining the import mapping table in step 716, the computer program determines if there is a mapping (step 718). The computer program does this by examining the import mapping table to find the unique identifier in the mapping table. For the example depicted in FIG. 3, the import mapping table 800 would contain an entry that maps a Microsoft® Equation object to StarOffice® Math. Therefore, the computer program determines that the formula 310 can be mapped from Microsoft®) Equation to StarOffice®D Math. The illustrated mapping table 800 also contains entries for other mappings, including, for example, entries that identify that a Microsoft® Word object maps to StarOffice® Writer and a Microsoft® Excel object maps to StarOffice® Calc.

Referring back to step 714, if the computer program determines that the user selectable setting for automatic conversion is not “enabled”, then the computer program determines whether the user has already selected a target format for conversion of the embedded object (step 720). If the user has already selected the target format by a user selectable setting in step 720, then the selected target format will be used as the target format for conversion (step 722). Otherwise the user will be prompted to enter a desired target format (step 724).

When the user requests to enter a target format for conversion or when this is required, for example in step 724, the computer program displays a window containing possible target formats on the video display 250 to enable the user to select a target format for conversion.

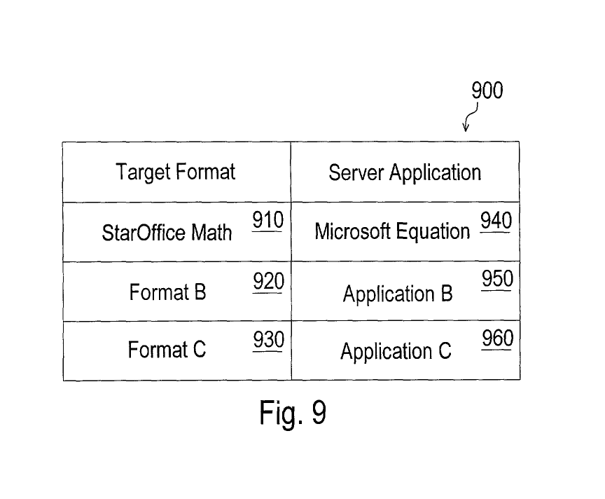

FIG. 9 schematically depicts a window 900 which is displayed on the video display 250 by the computer program for enabling a user to select a target application object format to convert to based on the server application program object format of the embedded object. As previously stated, the computer program can display the window 900 when, for example, the server application program is not present on the data processing system or when the user wants to edit an embedded object that has not been automatically converted. The window 900 displays conversion formats 910, 920 and 930 that are available on the data processing system based on the import filters that are available on the data processing system. The window 900 also displays corresponding server application programs 940, 950 and 960 that are available on the data processing system.

Referring to the target document of FIG. 3 as an example, after the target document is loaded and before the formula 310 is converted, the formula is in a Microsoft® Equation object format. When the user selects the formula 310 for editing, the computer program displays the window 900 on the video display 250. The window 900 displays Microsoft® Equation 940 as a server application program and StarOffice® Math 910 as a target format to which it can convert a Microsoft® Equation object. The user then selects the desired target application program object format, such as StarOffice® Math in this example, in the window 900 using the mouse button 270. When the computer program performs a conversion, the formula 310 will be converted to the StarOffice® Math object format.

Referring back to FIG. 7, once the computer program either determines that a mapping exists in step 718 or that the user has selected a target format in step 722, the computer program then determines whether the convert flag in the input mapping table for the embedded object is set to “enabled” instead of to “disabled” (step 726). For the example depicted in FIG. 3, the computer program determines if convert flag 814 is set to “enabled”.

If the computer program determines that the convert flag is set to “enabled” in step 726, then the computer program next determines whether the target application program, which is StarOffice®) Math in the example depicted in FIG. 3, is available on the data processing system (step 728).

If the computer program determines that the target application program is available in step 728, then the computer program uses a procedure call to query the target application program to detect the format of the embedded object (step 730). For the example depicted in FIG. 3, the computer program queries StarOffice® Math to detect the format of the formula 310. The target application program will identify to the computer program that it does not detect the format of the embedded object when, for example, the correct import filter is not available, the format of the embedded object is different than expected and there is no respective filter available, or the data in the embedded object is corrupted. Otherwise, the target application program will identify to the computer program that it detects the format of the embedded object.

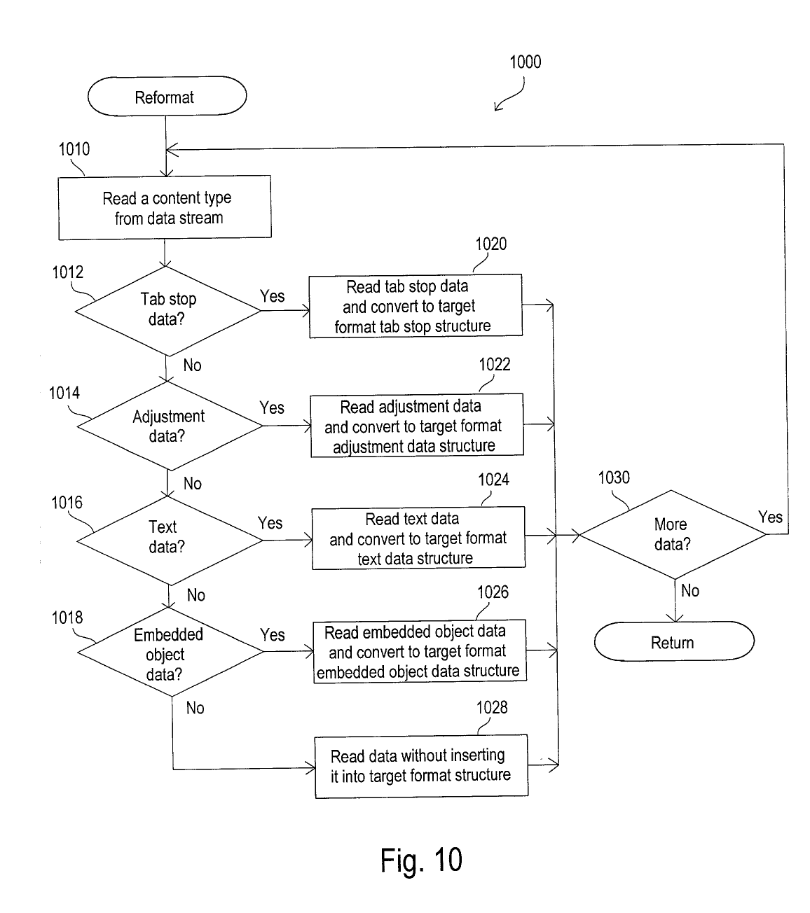

If the computer program correctly identifies the format of the formula 310 in step 730, then the computer program uses the target application program to create an embedded object of the target application program object format and, using an import filter of the target application program, reads the embedded object data 420 of the original embedded object into the newly created embedded object (step 732). For the example depicted in FIG. 3, the computer program uses StarOffice® Math to create a StarOffice® Math embedded object. Using a StarOffice® Math import filter that imports Microsoft® Equation objects into the StarOffice® Math object format, the computer program reads the embedded object data 420 of the formula 310 into the newly created StarOffice® Math embedded object. The conversion step 732 will be described in more detail below with reference to FIG. 10.

After the embedded object has been converted in step 732, the computer program displays the reformatted embedded object on the video display (step 734).

If the computer program does not recognize the unique identifier in step 710, the user selection to maintain the embedded object in its original format is “enabled” in step 712, a mapping does not exist in step 718, the convert flag is not set to “enabled” in step 726, the target application program is not available in step 728, or the format of the embedded object cannot be detected in step 730, then the computer program displays the embedded object in the target document without performing a conversion (step 736). In this case, referring to the example depicted in FIG. 3, the formula 310 cannot be edited if the server application program is not available on the data processing system. Depending on the contents of the original embedded object's Metafile, the computer program may not even display the original embedded object.

Therefore, in step 736, in the cases where the user selection to maintain the embedded object in its original format is set to “enabled” or the convert flag is not set to “enabled”, the computer program loads the embedded object into the target document without performing a conversion. This avoids introducing the possibility of any information loss, which may occur as a result of a conversion, when the user may want to view the embedded object but may not want to edit the embedded object.

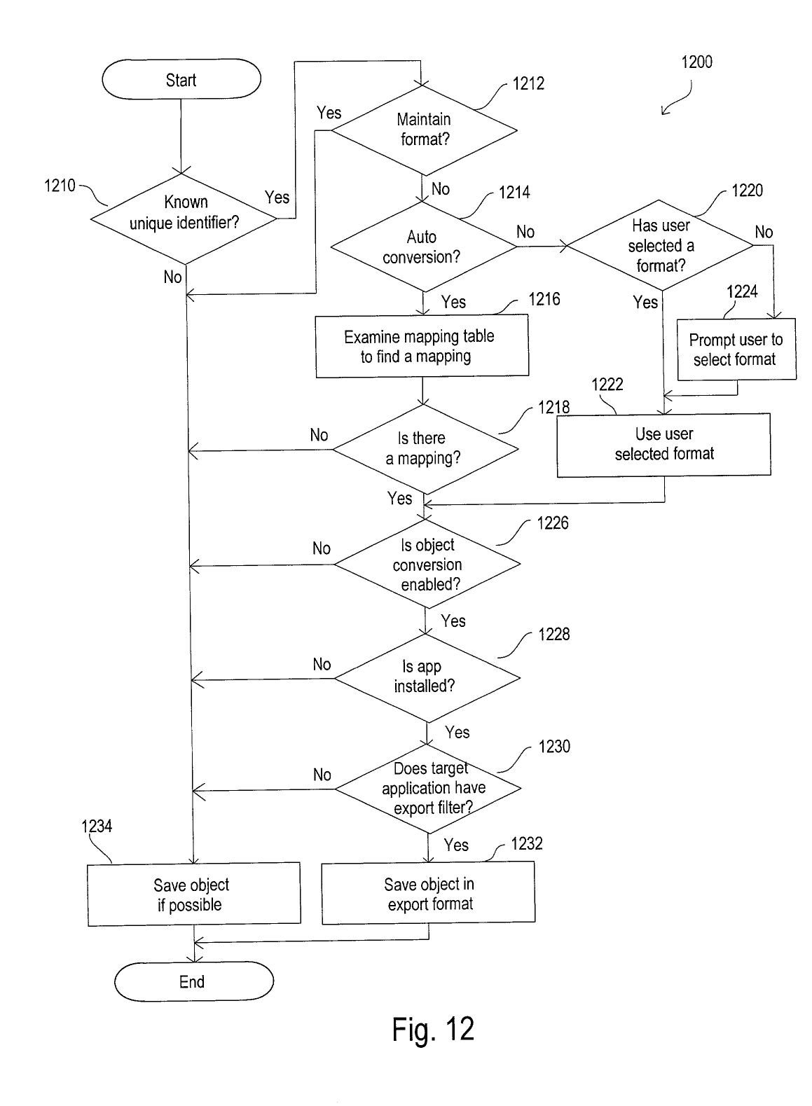

FIG. 10 depicts a flow diagram 1000 illustrating the steps for converting the embedded object from its server application program object format to a target application program object format. The process 1000 can be performed during step 732 of FIG. 7 and during step 1232 of FIG. 12, which will be described below. As discussed above, the computer program first uses the target application program to create an embedded object of the target application program object format. Then, the computer program uses the target application program import filter to read the embedded object data of the original embedded object into the newly created embedded object.

In more detail, as the computer program reads the data stream of the embedded object data of the embedded object, it identifies each content type that is present in the embedded object data (step 1010). The content types may comprise, for example, tab stop data, format adjustment data, text data, and embedded object data. One of skill in the art will appreciate that filters can read specific content types. For the example depicted in FIG. 3, the StarOffice® Math import filter may read a text data content type. If the import filter identifies a tab stop data content type (steps 1012), then the import filter will read the tab stop data content of the embedded object data and place the tab stop data content into the proper place in the newly created embedded object structure (steps 1020). If the import filter identifies an adjustment data content type (step 1014), then the import filter will read the adjustment data content of the embedded object data and place the adjustment data content into the proper place in the newly created embedded object structure (step 1022). If the import filter identifies a text data content type (step 1016), then the import filter will read the text data content of the embedded object data and place the text data content into the proper place in the newly created embedded object structure (step 1024). If the import filter identifies an embedded object data content type (step 1018), then the import filter will read the embedded object data content of the embedded object data and place the embedded object data content into the proper place in the newly created embedded object structure (step 1026).

For example, assume that there is an embedded object which is in a simplified HTML format and the computer program is to convert the embedded object to an ASCII text document format. The embedded object, which is in the simplified HTML format, has the following format:

<HTML>

<HEAD>

<TITLE>A simple document</TITLE>

</HEAD>
<BODY>

<P>This the first paragraph.</P>
<P>This is the second paragraph.</P>
<P>This is the third paragraph.</P>

</BODY>

</HTML>

According to this simplified HTML format, any information between a “<P>” and a “</P>” comprises text. Any information between the “<TITLE>” and the “</TITLE>” comprises the title. And anything else, especially anything between a “<” and a “>”, is structural information that is specific to the simplified HTML format.

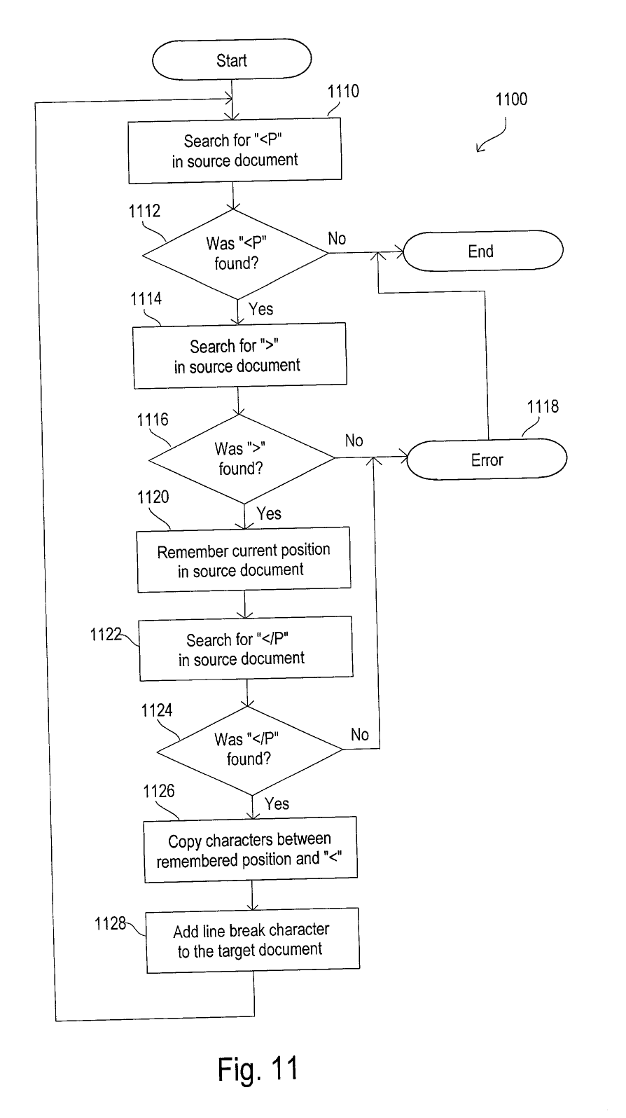

The computer program first creates a new embedded object with the ASCII text document format. Then during conversion, the computer program reads the data stream of the original embedded object data as sequential characters from the start of the original embedded object data to the end. In this case, since the target format is an ASCII text document format, the computer program searches for ASCII text in the data stream and inserts the ASCII text into the newly created embedded object. This is explained with reference to the process 1100 in FIG. 11.

Since ASCII text is present in the original embedded object between the “<P>” and “</P>” delimiters, the computer program searches the data stream for a “<P” (step 1110). If the computer program does not find a “<P”, then the conversion ends. If the computer program finds a “<P” (step 1112), then it searches the data stream for a “>” (step 1114). If the computer program does not find a “>” (step 1116), then there is an error in the original embedded object format and the conversion ends (step 1118). If the computer program finds a “>” in step 1116, then it remembers the current position in the original embedded object (step 1120). The computer program then searches the data stream for a “</P” (step 1122). If the computer program does not find a “</P” (step 1124), then there is an error in the original embedded object format and the conversion ends (step 1118). If the computer program finds a “</P” in step 1124, then it inserts any character between the remembered position in the original embedded object and the “<” to the newly created embedded object (step 1126). The computer program then inserts a line feed character after the inserted characters in the newly created embedded object (step 1128). The computer program then returns to step 1110.

After the conversion, the resultant newly created embedded object, which has an ASCII text document format, contains the paragraphs of the original embedded object, delimited by line feed characters. The newly created embedded object has the following format:

This is the first paragraph.

This is the second paragraph.

This is the third paragraph.

One of skill in the art will appreciate that conversion steps 1020, 1022, 1024 and 1026 depicted in FIG. 10 comprise processes similar to the process 1100 depicted in FIG. 11, but with algorithms appropriate for converting embedded object data to their appropriate target format.

Referring back to FIG. 10, if the import filter does not know the content type, then the import filter will read the content of the embedded object data, but will not insert it into the newly created embedded object structure (step 1028). The computer program will continue to read the data stream using the import filter until there is no more data in the data stream (step 1030).

Once the conversion is completed, the original embedded object is deleted. Thus, the embedded object is converted to the target format and the user will be able to edit the embedded object.

During processing of the target document, the user can request the computer program to save the target document to the secondary storage 240. Before requesting to save the target document, the user can select a format in which the edited embedded object will be saved in the target document. And the format in which the edited embedded object will be saved does not have to be the same as format in which the target document itself is saved. In the example depicted in FIG. 3, the formula 310 can be saved, for example, in a StarOffice® Math object format or a Microsoft® Equation object format and the target document can be saved, for example, in a Microsoft® Word format.

When the computer program exports the target document, for example, from memory 230 to secondary storage 240, the computer program identifies any embedded objects that are present in the target document by using an export filter, which is similar to an import filter as described above. FIG. 12 depicts a flow diagram 1200 illustrating the steps of saving an embedded object that has been found in a target document. The process 1200 depicted in FIG. 12 is similar to the process 700 depicted in FIG. 7, with a few differences, which will be discussed below.

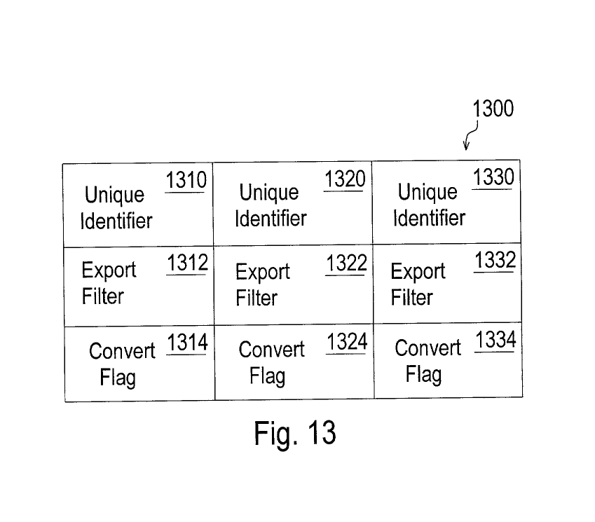

The computer program determines whether it recognizes the unique identifier of the embedded object by examining an export mapping table (step 1210). A sample export mapping table is depicted in FIG. 13. The export mapping table 1300 that is depicted in FIG. 13 has entries for three unique identifiers 1310, 1320 and 1330. For each unique identifier, such as embedded object identifier 1310, the export mapping table 1300 has an entry for a target application program export filter 1312 and a convert flag 1314 indicating whether the embedded object should be converted to the target application program export filter 1312 format. Each of the export mapping table 1300 entries is similarly configured. The convert flag 1314 is set to “enabled” when the embedded object should be converted and is set to “disabled” when the embedded object should not be converted. The computer program sets the convert flag 1314 based on an input request from the user to enable conversion. The default setting of the convert flag 1314 is “enabled”.

In the example illustrated in FIG. 13, the export mapping table 1300 can contain, for example, an entry that maps a StarOffice® Math object to Microsoft® Equation object. Therefore, referring to the example depicted in FIG. 3, the computer program determines that the formula 310 can be mapped from StarOffice® Math to Microsoft® Equation. The illustrated export mapping table 1300 also contains entries for other mappings.

Referring back to FIG. 12, if the computer program does recognize the unique identifier in step 1210, then it determines whether the user selectable setting for maintaining the embedded object format is set to “enabled” (step 1212).

If the user selectable setting is “enabled” in step 1212, then the computer program determines whether the user selectable setting for automatic conversion is set to “enabled” (step 1214). If automatic conversion is “enabled” in step 1214, then the computer program examines the export mapping table, in a process similar to examining the import mapping table described above with respect to FIG. 7. The computer program then determines if there is a mapping between the unique identifier of the embedded object and a target application program (step 1218). The processes disclosed in these steps is similar to the processes disclosed in the steps of FIG. 7.

If automatic conversion is not enabled in step 1214, then the computer program determines whether the user has already selected a target format for conversion (step 1220). If the user has already selected a target format for conversion in step 1220, then the computer program uses the selected target format (step 1222). If the user has not already selected a target format for conversion, then the computer prompts the user to select a target format for conversion (step 1224).

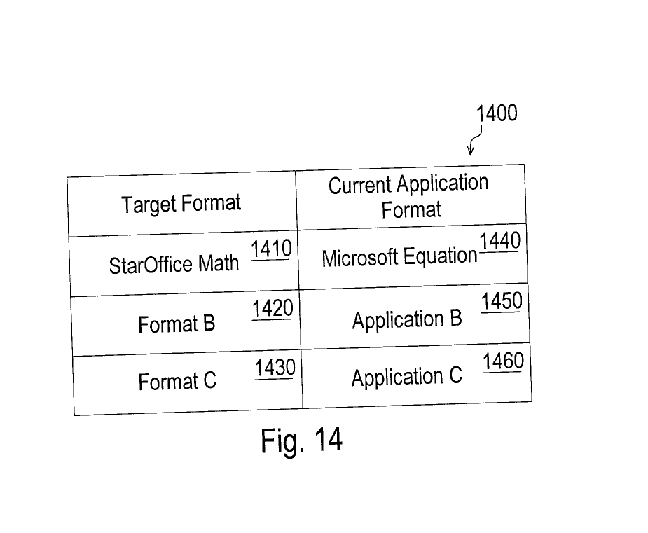

If the user is required to choose a target format for conversion in step 1224, then the computer program can display a window 1400, as depicted in FIG. 14. The window 1400 displays conversion formats 1410, 1420 and 1430 that are available on the data processing system based on export filters that are available on the data processing system. The window 1400 also displays corresponding current application program object formats 1440, 1450 and 1460 that are available on the data processing system.

Referring back to FIG. 12, if the computer program determines either that there is a mapping in step 1218 or that the user has selected a target format for conversion in step 1128, then the computer program determines whether the convert flag for the embedded object is set to “enabled” (step 1226). If the convert flag is set to “enabled” in step 1226, the computer program determines whether the target application program is available (step 1228). The processing disclosed in these steps is similar to those disclosed above with respect to FIG. 7.

If the computer program determines that the target application program is available in step 1228, then the computer program determines whether the target application program has the appropriate export filter to perform the conversion (step 1230).

If the target application program has the appropriate export filter, then the computer program converts the format of the embedded object to the target application program format as discussed above with respect to FIG. 7. The computer program then saves the target document to the secondary storage 240 with the newly created embedded object in its new format (step 1232).

If the computer program does not recognize the unique identifier in step 1210, the user selection to maintain the embedded object in its original format is “enabled” in step 1212, a mapping does not exist in step 1218, the convert flag is not set to “enabled” in step 1226, the target application program not available in step 1228, or the target application program does not have the appropriate filter in step 1230, then the computer program saves the embedded object into the target document, if possible, without performing a conversion (step 1234).

As discussed above, the computer program can present to the user one or more options for converting an embedded object. For example, the computer program can present the user with an option to convert an embedded object to a specific application format when the embedded object is imported or edited. Also, as discussed above, the computer program can present the user with an option to convert an embedded object to a specific application format when the target document is saved.

The computer program can provide different options to the user for determining whether an embedded object is to be converted at all and for determining the target format for conversion. The computer program may provide the user with a set of user-configurable options to configure the manner in which embedded objects are handled.

In an embodiment, when a server application program is not present on the data processing system, the computer program automatically converts an embedded object. The automatic conversion can take place either when the target document is imported or when the user selects an embedded object for editing. The computer program can either carry out the automatic conversion based on user settings, such as a setting that defines “automatically convert all Microsoft® Equation objects into StarOffice® Math objects”, or carry out the automatic conversion based on a check of the data processing system configuration. In the latter case, based on the application program object format of the embedded object, the filters and application programs available on the data processing system and the user settings, the computer program may then choose a suitable format into which the embedded object is converted.

As discussed above, rather than carrying out an automatic conversion when an embedded object is detected which needs conversion, the user can be prompted by the computer program to select whether to perform a conversion and to select a target format before the conversion is performed. The computer program can either prompt the user with window 1300 for each embedded object or prompt the user once for a selection that will be performed for each embedded object in the target document. The first alternative has the advantage that the user completely controls the format of each embedded object. Similarly, when saving the target document, the computer program can either prompt the user with window 1400 for each embedded object or prompt the user once for a selection that will be performed for each embedded object in the target document. Accordingly, the user may request to save the embedded object into a different format, possibly even different from both the original format and the format used for editing. This interactive conversion procedure is also advantageous if no suitable target format could be detected automatically by the computer program. This may, for example, be the case when, due to a corruption of some files on the data processing system, the object type of the embedded object cannot be correctly determined, but nevertheless the embedded object can be converted and then edited based on a conversion format selected of the user.

In an embodiment, the computer program performs more than one conversion step to facilitate editing of the embedded object. Assume that the embedded object has format A for which no corresponding server application program is available on the data processing system. A server application program, however, is available on the data processing system for embedded objects having format C. Assume, however, that there is no filter for direct conversion from format A to format C, but only filters for conversion from format A to format B and for conversion from format B to format C. Thus, when performing a converting step, the computer program first converts the embedded object from format A to intermediate format B, and then from intermediate format B to format C. Accordingly, the user can then edit the embedded object on the data processing system using the server application program available for embedded objects having format C.

Further, in an embodiment, the computer program checks which filters are available, then determines all possible filter conversion paths, and finally checks whether for a possible filter conversion path there would be a corresponding server application program available to edit the embedded object. If more than one filter conversion paths are available, the computer program presents the filter conversion paths on the video display 250 to enable the user to select which filter conversion path to use. The computer program can display the filter conversion paths in an order based on a criteria, such as the number of intermediate conversion steps. For example, the shortest filter conversion path having the least number of intermediate steps could be ranked first. If several paths have the same number of intermediate steps then the one having a target format which has been defined as preferred by the user could be ranked first.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but the present implementation may be implemented as a combination of hardware and software or in hardware alone. The invention may be implemented with both object-oriented and non-object-oriented programming systems. The scope of the invention is defined by the claims and their equivalents.

What is claimed is:

1. A method in a data processing system for processing a document containing an embedded object having a first format corresponding to a first program, the method comprising the steps of:
determining whether the first program is an unavailable program; and
when it is determined that the first program is an unavailable program, converting the embedded object into a second format different from the first format that is suitable for use with a second program that is available on the data processing system.

2. The method of claim 1, further comprising the step of:
receiving an indication of the second format from a user.

3. The method of claim 2, wherein the data processing system contains a plurality of programs, each with an associated format, and wherein the method further comprises the steps of:
determining which of the plurality of programs are available on the data processing system; and
displaying the associated formats of the available programs to the user.

4. The method of claim 1, further comprising the steps of:
receiving an indication of a third format from a user;
converting the embedded object into the third format; and
storing the embedded object.

5. The method of claim 1, wherein the converting step includes automatically identifying the second format.

6. The method of claim 1, further comprising the step of:
converting the embedded object into an intermediate format prior to converting the embedded object into the second format.

7. A method in a data processing system for processing a document containing an embedded object having a first format corresponding to a first program, the method comprising the steps of:
determining whether the first program is an unavailable program;
when it is determined that the first program is an unavailable program, converting the embedded object into a second format different from the first format that is suitable for use with a second program that is available on the data processing system;
receiving an indication of a third format from a user;
converting the embedded object into the third format; and
storing the embedded object in the third format.

8. A method in a data processing system containing a plurality of programs, each with an associated format, the data processing system for processing a document containing an embedded object having an originating format corresponding to an originating program, the method comprising the steps of:
determining whether the originating program is unavailable;
when it is determined that the originating program is unavailable,
determining which of the plurality of programs are available on the data processing system,
displaying the associated formats of the available programs to a user, and
receiving an indication of a selected one of the displayed formats from the user; and
converting the embedded object into the selected format.

9. A method in a data processing system for processing a document containing an embedded object having a first format corresponding to a first program, the data processing system having a memory, the method comprising the steps of:
initiating loading of the document into the memory;
while the document is being loaded,
determining whether the first program is unavailable,
when it is determined that the first program is unavailable,
converting the embedded object into a second format different from the first format that is suitable for use with a second program that is available on the data processing system;
after the document is loaded, receiving a request from the user to edit the embedded object; and
responsive to receiving the request from the user, converting the embedded object into a third format that is suitable for use with a third program that is available on the data processing system.

10. A data processing system comprising:
a secondary storage device comprising a target document containing an embedded object having a first format corresponding to a first program;
a memory comprising a computer program that determines whether the first program is an unavailable program, and, when it is determined that the first program is an unavailable program, converts the embedded object into a second format different from the first format that is suitable for use with a second program that is available on the data processing system; and
a processing unit that runs the computer program.

11. A computer-readable medium containing instructions that cause a data processing system to perform a method for processing a document containing an embedded object having a first format corresponding to a first program, the method comprising the steps of:
determining whether the first program is an unavailable program; and
when it is determined that the first program is an unavailable program, converting the embedded object into a second format different from the first format that is suitable for use with a second program that is available on the data processing system.

12. The computer-readable medium of claim 11, further comprising the step of:
receiving an indication of the second format from a user.

13. The computer-readable medium of claim 12, wherein the data processing system contains a plurality of programs, each with an associated format, and wherein the method further comprises the steps of:
determining which of the plurality of programs are available on the data processing system; and
displaying the associated formats of the available programs to the user.

14. The computer-readable medium of claim 11, further comprising the steps of:
receiving an indication of a third format from a user;
converting the embedded object into the third format; and
storing the embedded object.

15. The computer-readable medium of claim 11, wherein the converting step includes automatically identifying the second format.

16. The computer-readable medium of claim 11, further comprising the step of:
converting the embedded object into an intermediate format prior to converting the embedded object into the second format.

17. A computer-readable medium containing instructions that cause a data processing system to perform a method for processing a document containing an embedded object having a first format corresponding to a first program, the method comprising the steps of:
determining whether the first program is an unavailable program;
when it is determined that the first program is an unavailable program, converting the embedded object into a second format different from the first format that is suitable for use with a second program that is available on the data processing system;
receiving an indication of a third format from a user;
converting the embedded object into the third format; and
storing the embedded object in the third format.

18. A computer-readable medium containing instructions that cause a data processing system containing a plurality of programs, each with an associated format, to perform a method for processing a document containing an embedded object having an originating format corresponding to an originating program, the method comprising the steps of:
determining whether the originating program is unavailable;
when it is determined that the originating program is unavailable,
determining which of the plurality of programs are available on the data processing system,
displaying the associated formats of the available programs to a user, and
receiving an indication of a selected one of the displayed formats from the user; and
converting the embedded object into the selected format.

19. A computer-readable medium containing instructions that cause a data processing system to perform a method for processing a document containing an embedded object having a first format corresponding to a first program, the data processing system having a memory, the method comprising the steps of:
initiating loading of the document into the memory;
while the document is being loaded,
determining whether the first program is unavailable,
when it is determined that the first program is unavailable,
converting the embedded object into a second format different from the first format that is suitable for use with a second program that is available on the data processing system;
after the document is loaded, receiving a request from the user to edit the embedded object; and
responsive to receiving the request from the user, converting the embedded object into a third format that is suitable for use with a third program that is available on the data processing system.

20. A computer-readable memory device encoded with a data structure with entries, each entry reflecting embedded data in a document that is accessed by a host program which is encoded on the memory device and which is run by a processor in a system, each entry comprising:
a storage area in which is stored a first identifier of an original program that was utilized during creation of the embedded data and in which is stored a second identifier of an available program to be used for accessing the embedded data when the original program becomes unavailable in the system, wherein the available program is different than the original program.

21. The computer-readable memory device of claim 20, wherein the second identifier replaces the first identifier.

22. The computer-readable memory device of claim 20, wherein the original program becomes unavailable because the original program is not installed on the system.

23. The computer-readable memory device of claim 20, wherein each entry includes a second storage area in which is stored the embedded data in a format suitable for use with the original program and in which is stored the embedded data in a format suitable for use with the available program.

24. The computer-readable memory device of claim 23, wherein the embedded data in the format suitable for use with the available program replaces the embedded data in the format suitable for use with the original program.

25. A data processing system for processing a document containing an embedded object having a first format corresponding to a first program, the data processing system comprising:
means for determining whether the first program is an unavailable program; and
means for converting the embedded object into a second format different from the first format that is suitable for use with a second program that is available on the data processing system, when it is determined that the first program is an unavailable program.

26. A method in a data processing system comprising a document with data in a native format and with embedded data in a nonnative format, the embedded data suitable for use with a program, the method comprising the steps of:
receiving an indication of a different format suitable for use with a different program; and
converting the embedded data into the different format.

27. The method of claim 26, wherein the receiving step includes the step of:
receiving the indication from a user.

28. The method of claim 26, wherein the receiving step includes the step of:
retrieving the indication from storage.

29. The method of claim 26, wherein the steps of the method are performed while the document is being loaded into memory.

30. The method of claim 26, wherein the steps of the method are performed while the document is being displayed to a user.

31. A computer-readable medium containing instructions that cause a data processing system to perform a method, the data processing system comprising a document with data in a native format and with embedded data in a nonnative format, the embedded data suitable for use with a program, the method comprising the steps of:
receiving an indication of a different format suitable for use with a different program; and
converting the embedded data into the different format.

32. The computer-readable medium of claim 31, wherein the receiving step includes the step of:
receiving the indication from a user.

33. The computer-readable medium of claim 31, wherein the receiving step includes the step of:
retrieving the indication from storage.

34. The computer-readable medium of claim 31, wherein the steps of the method are performed while the document is being loaded into memory.

35. The computer-readable medium of claim 31, wherein the steps of the method are performed while the document is being displayed to a user.
